(19) United States
(12) Patent Application Publication
(10) Pub. No.: US 2022/0226975 A1
(43) Pub. Date: Jul. 21, 2022

(54) Dislodgement Alert Structure of Torque Wrench

(71) Applicant: KABO Tool Company, Taichung City (TW)

(72) Inventor: Chih-Ching Hsieh, Taichung City (TW)

(21) Appl. No.: 17/645,981

(22) Filed: Dec. 25, 2021

(30) Foreign Application Priority Data
Jan. 19, 2021 (TW) 110101903

(51) Int. Cl. B25B 23/142

(52) U.S. Cl. CPC B25B 23/1427

(57) ABSTRACT

A dislodgement alert structure of a torque wrench includes a tube, a tool head, a supporting base, and a dislodgeable element. The tube has a front-rear, or longitudinal, direction and a lateral, or transverse, direction. The tool head has a front recessed portion and is pivotally provided in, and can be pivoted in the transverse direction of, the tube. The supporting base has a front end with a rear recessed portion and a rear end with an elastic element. The dislodgeable element has front and rear ends each having a width in the transverse direction and has a height in the longitudinal direction. The height has a smaller dimension than the widths to hinder the dislodgeable element from being turned between the recessed portions. The elastic element may have a relatively low elastic modulus to reduce the load, and facilitate adjustment of the elastic force, of the elastic element.

### BACKGROUND OF THE INVENTION

### 1. Technical Field

The present invention relates to a hand tool and more particularly to a dislodgement alert structure of a torque wrench, wherein the dislodgement alert structure includes a dislodgeable element with relatively long turning sides that allow the elastic modulus of an elastic element of the dislodgement alert structure to be reduced.

### 2. Description of Related Art

Some hand tools have an adjustable torque mechanism that allows the torque to be applied during operation to be set. A conventional torque mechanism is generally so designed that when the torque applied reaches a preset torque value, an element of the mechanism is dislodged, thereby making a clicking sound to alert the user to the fact that the torque value has been reached, and to warn the user not to operate the hand tool any further. Referring to FIG. 1, a conventional torque wrench 10 is provided with a dislodgeable element 11, a rod 12, a supporting base 13, and a tube 14. The rod 12, the dislodgeable element 11, and the supporting base 13 are sequentially arranged in the tube 14. The dislodgeable element 11 is a cube, all of whose edges are of equal lengths. The rod 12 has a bottom portion provided with a recessed portion 121. The supporting base 13 has a top side provided with a recessed portion 131 facing the recessed portion 121 and has a bottom portion to which a spring 132 applies an elastic force. The dislodgeable element 11 is provided between the recessed portion 121 of the rod 12 and the recessed portion 131 of the supporting base 13, with the spring 132 pushing the supporting base 13 and the dislodgeable element 11 toward the rod 12. When the force acting on the rod 12 is greater than a preset pressure of the spring 132, the dislodgeable element 11 is pushed by the rod 12 and in turn pushes the recessed portion 131 downward. The recessed portion 121 of the rod 12 will also turn the dislodgeable element 11 such that the rod 12 is moved sideways and hits the tube 14, thereby making a sound to alert the user.

The six sides of the dislodgeable element 11 of the conventional torque wrench 10 have edges of equal lengths. Moreover, when a predetermined torque value is reached, the rod 12 will be displaced, with the recessed portion 121 causing an angular change of the dislodgeable element 11 such that the dislodgeable element 11 is turned between the recessed portion 121 of the rod 12 and the recessed portion 131 of the supporting base 13. As the pushing force required to dislodge, or turn, the dislodgeable element 11 is not great, the spring 132 must have a relatively high elastic modulus in design so as to prop the supporting base 13 while allowing the dislodgeable element 11 to be dislodged at predetermined torque values. When having a relatively high elastic modulus, however, the spring 132 will be under a relatively great load and may therefore undergo elastic fatigue relatively easily, meaning the precision of the spring 132 is very likely to be lowered after long-term use. Furthermore, when the spring 132 has a relatively high elastic modulus, a user is required to exert a relatively great rotating force in order to adjust, in particular to increase, the torque value, and this reduces the ease of operation.

### BRIEF SUMMARY OF THE INVENTION

The primary objective of the present invention is to provide a dislodgement alert structure in which a dislodgeable block has a greater length in the turning direction than the height of the dislodgeable block, and which allows the load on an elastic element of the dislodgement alert structure to be lowered.

To achieve the foregoing objective, the present invention provides a dislodgement alert structure of a torque wrench, wherein the dislodgement alert structure includes a tube, a tool head, a supporting base, and a dislodgeable element.

The tube has a receiving chamber that penetrates the front end of the tube. The front-rear direction of the tube is defined as a longitudinal direction, and the lateral direction of the tube is defined as a transverse direction.

The tool head has a head portion at the front end and a front recessed portion at the rear end. The front end and the rear end of the tool head are connected by a rod. The tool head is pivotally provided in the receiving chamber of the tube and can be pivoted in the lateral, or transverse, direction of the tube. The head portion is exposed from the tube. The front recessed portion is provided in the receiving chamber. When no force is applied to the tool head, there is a gap between the rod and the periphery of the receiving chamber.

The supporting base is provided in the receiving chamber of the tube. The front end of the supporting base is provided with a rear recessed portion facing the front recessed portion. The rear end of the supporting base is provided with an elastic element so that the supporting base can generate an elastic force acting toward the tool head.

The dislodgeable element has a front end and a rear end, each of which has a width in the lateral, or transverse, direction of the tube. The dislodgeable element further has a height in the longitudinal direction of the tube. The length of the height is less than the length of the widths.

The dislodgement alert structure of the torque wrench is so designed that the widths of the dislodgeable element are increased in length to make it more difficult to turn the dislodgeable element than in the prior art, thereby allowing the elastic element at the rear end of the supporting base to have a relatively low elastic modulus, which not only facilitates torque adjustment, but also reduces inaccurate measurement attributable to a damaged spring.

### BRIEF DESCRIPTION OF THE SEVERAL VIEWS OF THE DRAWINGS

In order for the examiner to better understand the objectives, features, and intended effect of the present invention, two preferred embodiments are detailed below with reference to the accompanying drawings, in which:

FIG. 1 is a sectional view of a conventional torque wrench;

FIG. 2 is a sectional view of the torque wrench according to a preferred embodiment of the present invention;

FIG. 3 is a partial sectional view of the torque wrench in FIG. 2, showing in particular how the tool head, the supporting base, and the dislodgeable element are coupled together;

FIG. 4 is a perspective view of the dislodgeable element of the torque wrench in FIG. 2;

FIG. 5 is similar to FIG. 3 except that the dislodgeable element is subjected to a force;

FIG. 6 is similar to FIG. 5 except that the torque applied by the torque wrench has reached a predetermined torque value, causing dislodgement of the dislodgeable element; and

FIG. 7 is a perspective view of the dislodgeable element in a second preferred embodiment of the invention, wherein the dislodgeable element has a longer transverse width than its longitudinal depth.

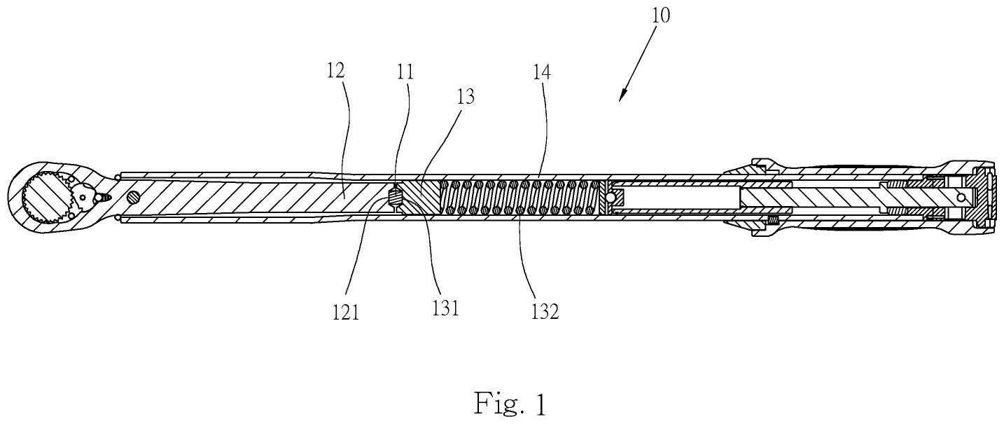

### DETAILED DESCRIPTION OF THE INVENTION

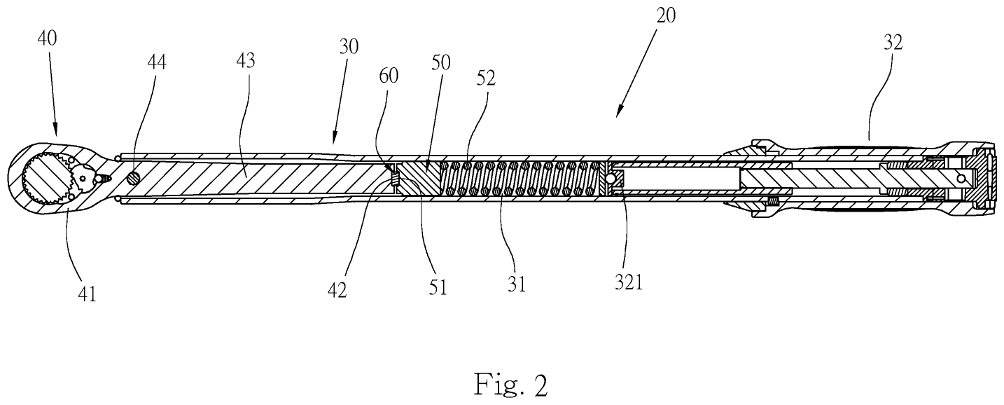

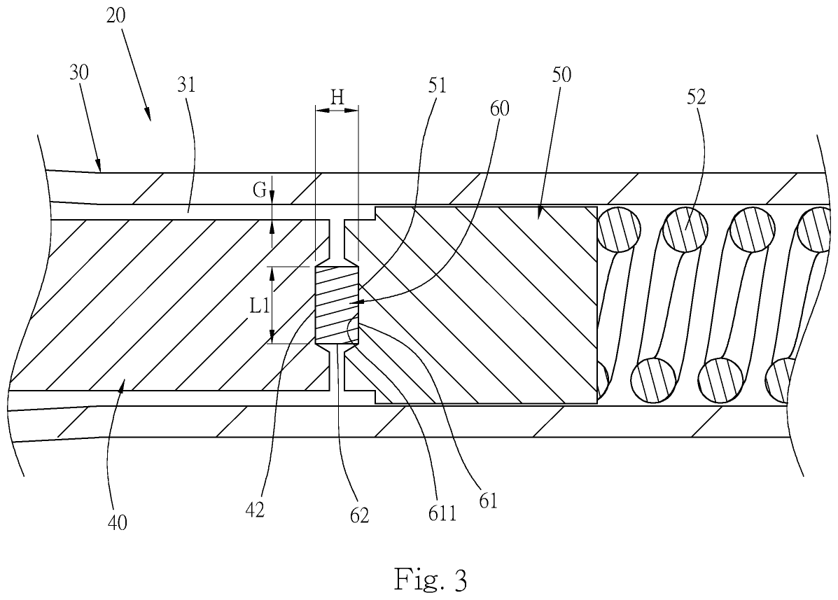

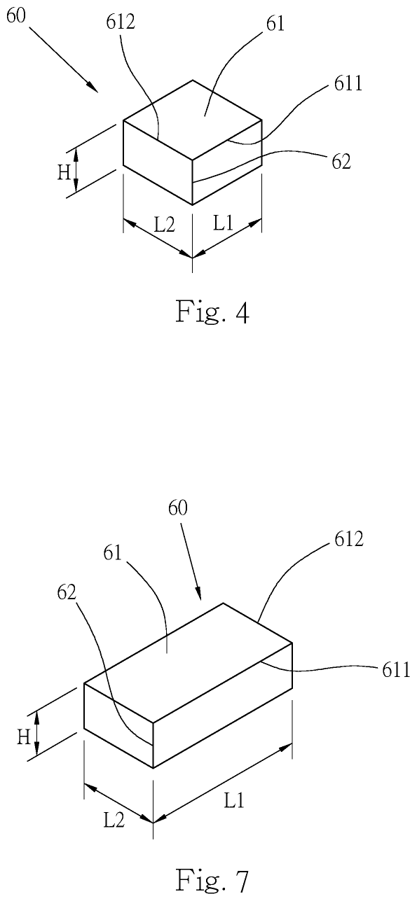

Referring to FIG. 2 to FIG. 4, the torque wrench 20 according to a preferred embodiment of the present invention includes a tube 30, a tool head 40, a supporting base 50, and a dislodgeable element 60.

The tube 30 has a receiving chamber 31 that penetrates the front and rear ends of the tube 30. The rear end of the tube 30 is pivotally provided with an adjustment handle 32. The adjustment handle 32 can be rotated at the rear end of the receiving chamber 31 and is provided with an adjusting block 321. The adjusting block 321 can be moved forward or backward in the receiving chamber 31 as the adjustment handle 32 is rotated. The front end-rear end direction of the tube 30 is defined as a longitudinal direction. The lateral direction of the tube 30 is defined as a transverse direction.

The tool head 40 has a head portion 41 at the front end and a front recessed portion 42 at the rear end. The front and rear ends of the tool head 40 are connected by a rod 43. The rear end of the tool head 40 is provided in the receiving chamber 31 of the tube 30. The head portion 41 is exposed from the tube 30. The front recessed portion 42 is provided in the receiving chamber 31. There is a gap G between the front recessed portion 42 and the peripheral wall of the receiving chamber 31 when the tool head 40 is not subjected to an applied force. A connecting element 44 is inserted through the tool head 40 and the tube 30 so that the rod 43 can be pivoted about an axis defined by the connecting element 44. The direction of the axis defined by the connecting element 44 is defined as an axial direction.

The supporting base 50 is provided in the receiving chamber 31 of the tube 30. The front end of the supporting base 50 is provided with a rear recessed portion 51 that faces the front recessed portion 42 of the tool head 40. The rear end of the supporting base 50 is provided with an elastic element 52 in order for the supporting base 50 to generate an elastic force that acts in the longitudinal direction of the tool head 40. The elastic element 52 has one end abutting against the rear end of the supporting base 50 and the opposite end abutting against the adjusting block 321 of the adjustment handle 32 of the tube 30. By varying the position of the adjusting block 321 in the receiving chamber 31 of the tube 30, the length of the elastic element 52 can be adjusted so as to adjust the magnitude of the elastic force applied by the elastic element 52 to the supporting base 50. The closer the adjusting block 321 is to the supporting base 50, the greater the elastic force generated by the elastic element 52.

The dislodgeable element 60 is provided between the tool head 40 and the supporting base 50. Each of the front and rear ends of the dislodgeable element 60 has a contact surface 61 for contact with the front recessed portion 42 of the tool head 40 or the rear recessed portion 51 of the supporting base 50. The contact surfaces 61 are quadrilaterals each having two widths 611 in the lateral, or transverse, direction of the tube 30 and two depths 612 perpendicular to the widths 611, wherein the two widths 611 and the two depths 612 have a length L1 and a length L2 respectively. In this embodiment, the length L1 of the widths 611 and the length L2 of the depths 612 are equal such that the contact surfaces 61 are squares. The dislodgeable element 60 further has a height 62 in the longitudinal direction of the tube 30. The length H of the height 62 is less than the lengths L1 and L2 of the widths 611 and depths 612 of the contact surfaces 61. The ratio of the length L1 of the widths 611 to the length H of the height 62 is 1.3-2.5, and so is the ratio of the length L2 of the depths 612 to the length H of the height 62. The relatively long widths 611 and depths 612 of the contact surfaces 61 not only contribute to a relatively large area of contact between the dislodgeable element 60 and the front recessed portion 42 and between the dislodgeable element 60 and the rear recessed portion 51, but also allow the rear recessed portion 51 of the supporting base 50 to push the dislodgeable element 60 toward the tool head 40 such that the tool head 40 is subjected to the elastic force of the elastic element 52, is thereby kept from pivoting toward either lateral side of the tube 30, and can therefore apply a predetermined torque to a workpiece (not shown).

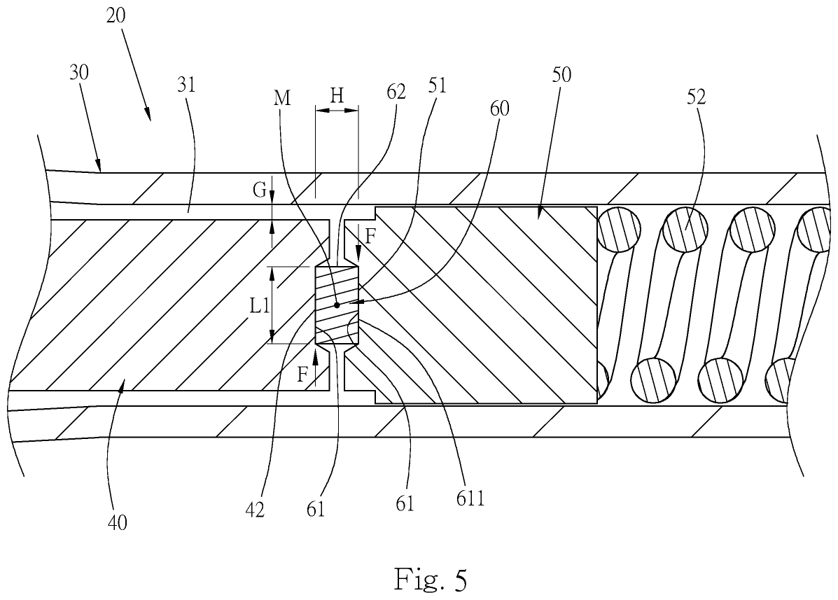

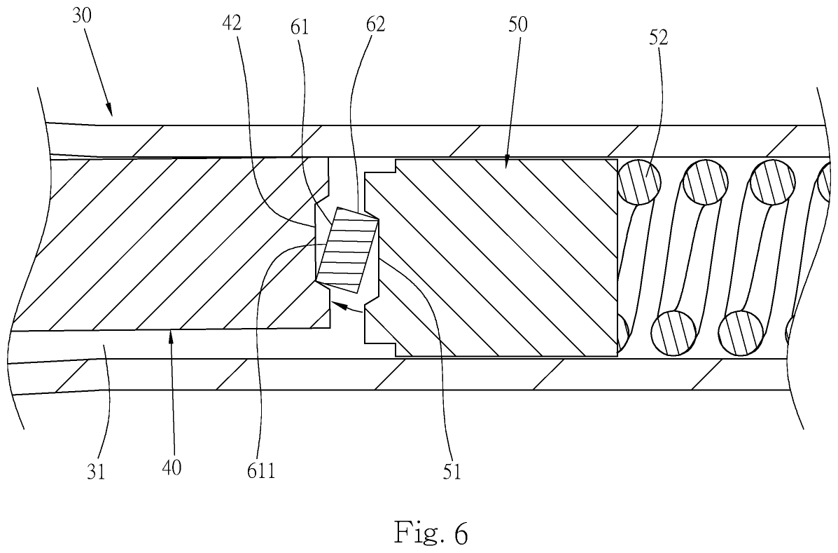

Before using the torque wrench 20, referring to FIG. 5 and FIG. 6, the position of the adjusting block 321 in the receiving chamber 31 of the tube 30 can be adjusted with the adjustment handle 32 in order to adjust the compressed length of the elastic element 52, the goal being for the elastic element 52 to generate an elastic force and thereby push the supporting base 50, the dislodgeable element 60, and the tool head 40 as desired. When a force is applied to the torque wrench 20 by a user holding the adjustment handle 32, the head portion 41 of the tool head 40 can apply a force to, and thereby tighten or loosen, an object such as a workpiece or socket, and in the meantime, the front recessed portion 42 at the rear end of the rod 43 will generate a force that is in the opposite direction of the force applied by the user and acts on the corresponding contact surface 61 of the dislodgeable element 60. The greater the force applied by the user is, the higher the torque generated by the head portion 41 of the tool head 40 will be, and the greater the opposite-direction force generated by the front recessed portion 42 will also be. As the lengths L1 and L2 of the widths 611 and depths 612 of the contact surfaces 61 of the dislodgeable element 60 are greater than the length H of the height 62 of the dislodgeable element 60, the areas of contact between the contact surfaces 61 and the front recessed portion 42 of the tool head 40 and the rear recessed portion 51 of the supporting base 50 are relatively great. Compared with its prior art counterparts, therefore, the dislodgeable element 60 can better distribute, and is less likely to be turned by, the force applied by the front recessed portion 42. It follows that the elastic element 52 is allowed to prop the supporting base 50 with a smaller elastic force than in the prior art. That is to say, the elastic element 52 may have a lower elastic modulus than in the prior art. In that case, the adjusting block 321 of the adjustment handle 32 will be subjected to a relatively small elastic force, meaning the elastic force that must be overcome in order to adjust the position of the adjusting block 321, i.e., to adjust the torque value, will be relatively small, and the adjustment can be made with relatively great ease via the adjustment handle 32. Furthermore, when the force applied to the head portion 41 is so great as to turn the dislodgeable element 60 between the front recessed portion 42 of the tool head 40 and the rear recessed portion 51 of the supporting base 50, the front recessed portion 42 generates a lateral force. More specifically, the tool head 40 is pivoted about an axis defined by the connecting element 44 when applying a force, and the front recessed portion 42 pushes, and thereby turns, the dislodgeable element 60 as a result. While doing so, the front recessed portion 42 pushes the rear recessed portion 51 of the supporting base 50 downward through the dislodgeable element 60 and overcomes the elastic force of the elastic element 52 so that the dislodgeable element 60 can be turned between the front recessed portion 42 and the rear recessed portion 51. When the dislodgeable element 60 is turned, the front recessed portion 42 is also laterally displaced such that a lateral side of the front recessed portion 42 hits the tube 30, producing a sound that alerts the user to the fact that a preset torque value is reached. Moreover, while the front recessed portion 42 is turning the dislodgeable element 60, the relatively short length H of the height 62 renders the distance between the lateral force F generated by the tool head 40 and the center of gravity M of the dislodgeable element 60 relatively short, so it is relatively difficult for the lateral force of the front recessed portion 42 to generate a torque high enough to turn, or rotate, the dislodgeable element 60. Consequently, the elastic element 52 at the rear end of the supporting base 50 may have a relatively low elastic modulus but is still capable of generating an elastic force great enough to support the supporting base 50. The relatively low elastic modulus also helps prevent elastic fatigue of the elastic element 52 as may otherwise result from the elastic element 52 generating a much greater elastic force and lead to a reduction in precision of the elastic element 52.

It is worth mentioning that the length L1 of the widths 611 of the contact surfaces 61 is greater than the lateral dimension of the gap G between the tube 30 and the tool head 40. Therefore, when the dislodgeable element 60 is turned along the direction of the widths 611 and causes the front recessed portion 42 to hit the tube 30, the angle through which the dislodgeable element 60 is turned is relatively small, and once the force applied by the user is removed, the dislodgeable element 60 can rapidly return to its original position, allowing the user to resume operation, i.e., to apply a force to the torque wrench 20 again.

FIG. 7 shows the dislodgeable element in the second preferred embodiment of the present invention. The second preferred embodiment is structurally the same as the previous embodiment except for the dislodgeable element. The identical structures in the two embodiments are indicated by the same reference numeral and will not be described repeatedly.

In the second preferred embodiment, the lengths L1 and L2 of the widths 611 and depths 612 of the contact surfaces 61 of the dislodgeable element 60 are not equal. The length L1 of the widths 611 is greater than the length L2 of the depths 612, but both the lengths L1 and L2 are greater than the length H of the height 62 of the dislodgeable element 60. In practice, the length L2 of the depths 612 may also be less than or equal to the length H of the height 62, and in that case the dislodgeable element 60 remains difficult to turn.

The dislodgement alert structure provided by the present invention includes a dislodgeable element whose widths have a greater length than the height of the dislodgeable element, and which therefore will not be easily turned by the reaction force of the tool head. A conventional dislodgeable element, by contrast, has widths equivalent to its height and requires the use of an elastic element of a relatively high elastic modulus to apply an elastic force to, and thereby push, the dislodgeable element. The dislodgement alert structure of the invention allows the elastic element to have a relatively low elastic modulus, which not only makes it easier to adjust the torque setting, but also contributes to protecting the elastic element from damage, extending the service life of the elastic element, and preventing the torque setting from being affected.

The embodiments described above serve only to demonstrate, but not to limit, the technical means of the present invention. All equivalent modifications of the invention shall fall within the scope of the patent protection sought by the applicant. The hand tool disclosed herein has a structure that is the first of its kind in the art. The hand tool also provides an improvement of a practical function. Therefore, a patent application for the invention is hereby filed according to law.

What is claimed is:

1. A dislodgement alert structure of a torque wrench, comprising:
a tube having a receiving chamber, the receiving chamber penetrating a front end of the tube, the tube having a front-rear direction defined as a longitudinal direction, the tube further having a lateral direction defined as a transverse direction;
a tool head having a front end with a head portion and a rear end with a front recessed portion, the front end and the rear end of the tool head being connected by a rod, the tool head being pivotally provided in the receiving chamber of the tube and being pivotable in the transverse direction of the tube, the head portion being exposed from the tube, the front recessed portion being provided in the receiving chamber, there being a gap between the rod and a periphery of the receiving chamber when the tool head is not subjected to an applied force;
a supporting base provided in the receiving chamber of the tube, the supporting base having a front end and a rear end, the front end of the supporting base being provided with a rear recessed portion facing the front recessed portion, the rear end of the supporting base being provided with an elastic element in order for the supporting base to generate an elastic force acting toward the tool head; and
a dislodgeable element having a front end and a rear end each having a width in the transverse direction of the tube, the dislodgeable element further having a height in the longitudinal direction of the tube, the height having a smaller length than the widths.

2. The dislodgement alert structure of claim 1, wherein each of the front end and the rear end of the dislodgeable element has a depth perpendicular to a corresponding said width such that a contact surface is defined between the depth and the corresponding width, and the two contact surfaces are in contact with the front recessed portion and the rear recessed portion respectively.

3. The dislodgement alert structure of claim 2, wherein the depth and the width of each of the front end and the rear end of the dislodgeable element have a same length.

4. The dislodgement alert structure of claim 2, wherein the depth and the width of each said contact surface of the dislodgeable element have different lengths respectively.

5. The dislodgement alert structure of claim 4, wherein the length of the depth of each said contact surface of the dislodgeable element is greater than the length of the height and less than a length of the corresponding width.

6. The dislodgement alert structure of claim 4, wherein the length of the depth of each said contact surface of the dislodgeable element is equal to the length of the height.

7. The dislodgement alert structure of claim 4, wherein the length of the depth of each said contact surface of the dislodgeable element is less than the length of the height.

8. The dislodgement alert structure of claim 1, wherein the width of each said contact surface of the dislodgeable element and the height of the dislodgeable element have a length ratio of 1.3-2.5.
